(19) United States
(12) Patent Application Publication
(10) Pub. No.: US 2009/0142639 A1
(43) Pub. Date: Jun. 4, 2009

(54) Seal system for solid oxide fuel cell and method of making

(76) Inventor: Steven Joseph Gregorski, Painted Post, NY (US)

Correspondence Address: CORNING INCORPORATED, SP-TI-3-1, CORNING, NY, 14831, US

(21) Appl. No.: 11/998,315

(22) Filed: Nov. 29, 2007

(51) Int. Cl. H01M 8/10

(52) U.S. Cl. 429/30

(57) ABSTRACT

A solid oxide fuel cell assembly is disclosed comprising a felt seal and a spacer capable of limiting a compressive force applied to the seal system. Also disclosed is a solid oxide fuel cell assembly comprising a seal system comprising a felt seal, wherein at least a portion of the felt seal defines a cavity in contact with a ceramic electrolyte sheet and wherein the cavity comprises at least one of a solid metal wire, a powdered metal, a sintered metal, a powdered ceramic, a sintered ceramic, or a combination thereof. Also disclosed is a solid oxide fuel cell assembly comprising a labyrinth seal that defines a cavity in which at least a portion of a ceramic electrolyte sheet is disposed. Also disclosed is a mounted ceramic electrolyte sheet comprising a ceramic electrolyte sheet and a metal frame positioned adjacent thereto, and a labyrinth seal.

### STATEMENT REGARDING GOVERNMENT SUPPORT

This invention was made with government support under Cooperative Agreement 70NANB4H3036, awarded by the National Institute of Standards and Technology (NIST). The United States government has certain rights in this invention.

### BACKGROUND OF THE INVENTION

1. Field of the Invention

The present invention relates to fuel cell devices and more particularly to solid oxide fuel cell devices that utilize designs and/or seal(s) that can minimize device failure.

2. Technical Background

Solid oxide fuel cells (SOFC) have been the subject of considerable research in recent years. Solid oxide fuel cells (SOFC) are electrochemical cells that convert chemical energy derived from a fuel, such as hydrogen and/or hydrocarbons, into electrical energy via electrochemical oxidation of the fuel at temperatures, for example, of about 700° C. to about 1000° C.

A typical SOFC comprises a negatively-charged oxygen-ion conducting electrolyte layer sandwiched between a cathode layer and an anode layer. Oxygen is reduced at the cathode and incorporated into the electrolyte, wherein oxygen ions are transported through the electrolyte to react with, for example, hydrogen at the anode.

SOFC devices are typically subjected to thermal-mechanical stresses due to the high operating temperatures and rapid temperature cycling of the device. Such stresses can result in deformation of device components and can adversely impact the operational reliability and lifetime of SOFC devices. Thermal and mechanical stress can be concentrated at the interface of device components. When a device is comprised of a thin flexible ceramic sheet as the electrolyte component in a SOFC, there can be a higher likelihood of premature device failure.

In a conventional design, a SOFC systems comprise multiple fuel cells that arranged in a stack. Individual fuel cells in the stack can be mounted to a frame structure which provides mechanical support for the individual devices and functions as a gas manifold to direct the fuel and other process gases. A seal can connect a frame to a device, such as a ceramic electrolyte sheet, and serve to minimize mechanical stress on the device by providing a cushion or supporting a cushion positioned between the device and the frame. For example, approaches to minimize mechanical stress on SOFC devices have included the use of patterned electrolyte sheets that compensate for induced strain and sealing materials that can minimize the build up of strain at the device bonding regions.

SOFC assemblies comprising a seal between the frame structure and the SOFC device can suffer from leakage of gas, such as fuel and/or oxidant, out of the device due to the permeability of the seal material. The loss of gas from the device can lead to inefficient device performance, costly device maintenance, and safety related issues. Conventional approaches to minimize leakage from a solid oxide fuel cell device include seals comprised of solid materials.

Thus, there is a need to address both the thermal mechanical integrity and gas permeability properties of solid oxide fuel cells and components thereof, along with other shortcomings associated with solid oxide fuel cells. These needs and other needs are satisfied by the articles, devices and methods of the present invention.

### SUMMARY OF THE INVENTION

The present invention relates to solid oxide fuel cell assembly, and particularly to solid oxide fuel cell assembly that utilize designs and/or seal(s) that can minimize device gas leakage and/or permeation. The present invention addresses at least a portion of the problems described above through the use of novel seal systems and designs.

In a first embodiment, the present invention provides a solid oxide fuel cell assembly comprising a first frame member, a second frame member, a ceramic electrolyte sheet having a first surface and an opposed second surface, the ceramic electrolyte sheet being at least partially disposed between the first and second frame member; and a seal system comprising a first felt seal connecting at least a portion of the first frame member to at least a portion of the first surface, and a second felt seal connecting at least a portion of the second frame member to at least a portion of the second surface; and a spacer disposed between the first frame member and the second frame member and positioned adjacent to the ceramic electrolyte sheet, the spacer being capable of limiting a compressive force applied to the seal system.

In a second embodiment, the present invention provides a solid oxide fuel cell assembly comprising a first frame member, a second frame member, a ceramic electrolyte sheet having a first surface and an opposed second surface, the ceramic electrolyte sheet being at least partially disposed between the first and second frame member; and a seal system comprising a first felt seal connecting at least a portion of the first frame member to at least a portion of the first surface, and a second felt seal connecting at least a portion of the second frame member to at least a portion of the second surface; wherein at least one of the first felt seal and/or the second felt seal define a cavity in contact with the ceramic electrolyte sheet, and wherein the cavity comprises at least one of: a solid metal wire, a powdered metal, a sintered metal, a powdered ceramic, a sintered ceramic, or a combination thereof.

In a third embodiment, the present invention provides a solid oxide fuel cell assembly comprising a first frame member, a second frame member, a ceramic electrolyte sheet having a first surface and an opposed second surface, the ceramic electrolyte sheet being at least partially disposed between the first and second frame member; and a seal system comprising a first felt seal connecting at least a portion of the first frame member to at least a portion of the first surface, and a second felt seal connecting at least a portion of the second frame member to at least a portion of the second surface, and a labyrinth seal comprising a secondary seal material in contact with at least a portion of the first frame member and at least a portion of the second frame member, wherein the secondary seal material defines a channel, and wherein at least a portion of the ceramic electrolyte sheet is disposed in at least a portion of the channel.

In a fourth embodiment, the present invention provides a mounted ceramic electrolyte sheet comprising a ceramic electrolyte sheet having a first surface and an opposed second surface, a metal frame positioned adjacent to the ceramic electrolyte sheet, and a labyrinth seal, wherein the labyrinth seal defines a first channel and an opposite disposed second channel, wherein at least a portion of the ceramic electrolyte sheet is disposed in at least a portion of the first channel, and wherein at least a portion of the metal frame is disposed in at least a portion of the second channel.

Additional embodiments and advantages of the invention will be set forth, in part, in the detailed description and any claims which follow, and in part will be derived from the detailed description or can be learned by practice of the invention. The advantages described below will be realized and attained by means of the elements and combinations particularly pointed out in the appended claims. It is to be understood that both the foregoing general description and the following detailed description are exemplary and explanatory only and are not restrictive of the invention as disclosed.

### BRIEF DESCRIPTION OF THE DRAWINGS

The accompanying drawings, which are incorporated in and constitute a part of this specification, illustrate certain embodiments of the present invention and together with the description, serve to explain, without limitation, the principles of the invention. Like numbers represent the same elements throughout the figures.

FIG. 1 is a diagram illustrating various components of a solid oxide fuel cell assembly, including a frame, seal, and ceramic electrolyte sheet, in accordance with the various embodiments of the present invention.

FIG. 2 is a photograph illustrating the various embodiments diagrammed in FIG. 1.

FIG. 3 is a diagram illustrating various components of a solid oxide fuel cell assembly, including a frame, seal, ceramic electrolyte sheet, and spacer, in accordance with the various embodiments of the present invention.

FIG. 4 is a schematic diagram illustrating air and/or process gas flow in and out of a solid oxide fuel assembly.

FIG. 5 is a diagram illustrating various components of a solid oxide fuel cell assembly, including a frame, seal comprising cement comprising a solid material, and ceramic electrolyte sheet, in accordance with the various embodiments of the present invention.

FIG. 6 is a photograph illustrating the various embodiments diagrammed in FIG. 5.

FIG. 7 is a schematic diagram illustrating the fabrication process of a solid oxide fuel cell assembly comprising various components including a frame, seal comprising cement, spacer, and ceramic electrolyte sheet wherein the ceramic electrolyte sheet comprises a coating that can be volatilized during a device compression process leaving a labyrinth seal.

FIG. 8 is a schematic diagram illustrating the fabrication process of a solid oxide fuel cell assembly comprising various components including a frame comprising a coating, seal, ceramic electrolyte sheet comprising a coating, and a cement barrier in overlying registration with a frame and ceramic electrolyte sheet comprising a coating, wherein coatings can be volatilized during a device compression process, and wherein a cement seal can be compressed leaving a labyrinth seal.

FIG. 9 is a schematic diagram illustrating the fabrication process of a solid oxide fuel cell assembly comprising various components illustrated in FIG. 8, wherein the frame and spacer can be removed after a device molding process.

FIG. 10 is a photograph illustrating the various embodiments diagrammed in FIG. 9.

FIG. 11 is a schematic diagram illustrating a molding process of a cement labyrinth design of a solid oxide fuel cell and the combination of the same with a sheet metal frame.

### DETAILED DESCRIPTION OF THE INVENTION

The present invention can be understood more readily by reference to the following detailed description, examples, and claims, and their previous and following description. However, before the present compositions, articles, devices, and methods are disclosed and described, it is to be understood that this invention is not limited to the specific compositions, articles, devices, and methods disclosed unless otherwise specified, as such can, of course, vary. It is also to be understood that the terminology used herein is for the purpose of describing particular embodiments only and is not intended to be limiting.

The following description of the invention is provided as an enabling teaching of the invention in its currently known embodiments. To this end, those skilled in the relevant art will recognize and appreciate that many changes can be made to the various embodiments of the invention described herein, while still obtaining the beneficial results of the present invention. It will also be apparent that some of the desired benefits of the present invention can be obtained by selecting some of the features of the present invention without utilizing other features. Accordingly, those who work in the art will recognize that many modifications and adaptations to the present invention are possible and can even be desirable in certain circumstances and are a part of the present invention. Thus, the following description is provided as illustrative of the principles of the present invention and not in limitation thereof.

Disclosed are materials, compounds, compositions, and components that can be used for, can be used in conjunction with, can be used in preparation for, or are products of the disclosed method and compositions. These and other materials are disclosed herein, and it is understood that when combinations, subsets, interactions, groups, etc. of these materials are disclosed that while specific reference of each various individual and collective combinations and permutation of these compounds may not be explicitly disclosed, each is specifically contemplated and described herein. Thus, if a class of substituents A, B, and C are disclosed as well as a class of substituents D, E, and F and an example of a combination embodiment, A-D is disclosed, then each is individually and collectively contemplated. Thus, in this example, each of the combinations A-E, A-F, B-D, B-E, B-F, C-D, C-E, and C-F are specifically contemplated and should be considered disclosed from disclosure of A, B, and C; D, E, and F; and the example combination A-D. Likewise, any subset or combination of these is also specifically contemplated and disclosed. Thus, for example, the sub-group of A-E, B-F, and C-E are specifically contemplated and should be considered disclosed from disclosure of A, B, and C; D, E, and F; and the example combination A-D. This concept applies to all embodiments of this disclosure including, but not limited to any components of the compositions and steps in methods of making and using the disclosed compositions. Thus, if there are a variety of additional steps that can be performed it is understood that each of these additional steps can be performed with any specific embodiment or combination of embodiments of the disclosed methods, and that each such combination is specifically contemplated and should be considered disclosed.

In this specification and in the claims which follow, reference will be made to a number of terms which shall be defined to have the following meanings:

As used herein, the singular forms “a,” “an” and “the” include plural referents unless the context clearly dictates otherwise. Thus, for example, reference to a “compound” includes embodiments having two or more such compounds, unless the context clearly indicates otherwise.

“Optional” or “optionally” means that the subsequently described event or circumstance can or cannot occur, and that the description includes instances where the event or circumstance occurs and instances where it does not.

Ranges can be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

As used herein, a “wt. %” or “weight percent” or “percent by weight” of a component, unless specifically stated to the contrary, refers to the ratio of the weight of the component to the total weight of the composition in which the component is included, expressed as a percentage.

As used herein, a “felt” or “felt composition,” unless specifically stated to the contrary, refers to any physical form of matted and/or milled fiber that can be non-interlocked, partially interlocked, and/or mechanically interlocked, and can include inorganic powders and/or colloids, organic and/or inorganic binders, polymer surface coatings embedded with organic and/or inorganic materials, combinations thereof, and/or other components typically used in or that can provide similar functional properties when used in a solid oxide fuel cell.

As briefly discussed above, the present invention provides novel solid oxide fuel cell designs that can reduce and/or prevent device failure due to thermal mechanical stresses and/or minimize gas leakage during device operation. The designs and methods of the present invention can lead to improved thermal mechanical integrity and reduced gas leakage in a solid oxide fuel cell device.

A conventional solid oxide fuel cell assembly comprises a ceramic electrolyte sheet attached to a frame. Depending on the specific geometry, such as, for example, planar or tubular, of a ceramic electrolyte sheet or fuel cell device, a frame can be peripherally attached to at least a portion of a ceramic electrolyte sheet, such as an edge. A frame can also be peripherally attached to, for example, a planar ceramic electrolyte sheet such that the frame surrounds the ceramic electrolyte sheet and contacts the edge of the sheet in a picture frame fashion. Conventional seals, if used, can be positioned between a frame member and a ceramic electrolyte sheet.

The seals, devices, and methods of the present invention can be useful in attaching and/or sealing a ceramic electrolyte sheet to a frame member, for example a single ceramic electrolyte sheet to a frame member, attaching and/or sealing each of a plurality of ceramic electrolyte sheets, for example, in a fuel cell stack, to a respective frame member, or attaching and/or sealing each of a plurality of ceramic electrolyte sheets not having a conventional frame to each other so as to provide an electrode chamber between each of the plurality of ceramic electrolyte sheets.

It should be noted that each of the components, individual seals, and method steps disclosed herein can be combined with or performed in any combination with one or more other components, individual seals, and method steps of the present invention. As such, the present invention is not intended to be limited to the specific embodiments recited.

Each of the seals and methods of the present invention can be used to peripherally attach a ceramic electrolyte sheet and a frame in various configurations. In various embodiments, the present invention provides a solid oxide fuel cell comprising a frame, a ceramic electrolyte sheet, and a seal connecting at least a portion of the frame to at least a portion of the ceramic electrolyte sheet, between both the portion of the frame and the portion of the ceramic electrolyte sheet connected to the seal.

In various embodiments, a ceramic electrolyte sheet can be peripherally attached to a seal and/or frame to provide a discontinuous seal such that at least a portion of the edge of the ceramic electrolyte sheet is in contact with a seal and/or frame member. Such a discontinuous seal can optionally be combined with one or more other seals to provide a continuous seal. In other embodiments, a ceramic electrolyte sheet can be peripherally attached to a seal and/or frame to provide a continuous seal such that an electrode chamber is formed between the ceramic electrolyte sheet and either an adjacent ceramic electrolyte sheet and/or a frame member. Accordingly, various geometric arrangements and degrees of overlying registration described herein are not intended to limit the present invention to those embodiments. Further, although the electrolytes, seals, support structures, and methods of the present invention are described below with respect to a solid oxide fuel cell, it should be understood that the same or similar electrolytes, electrodes, seals, and support structures can be used in other applications where a need exists to seal a ceramic or similarly functional article to another component.

Each of the seals and methods described herein comprise, in various embodiments, a ceramic electrolyte sheet. The ceramic electrolyte sheet can comprise any ion-conducting material suitable for use in a solid oxide fuel cell. In one embodiment, the electrolyte is comprised of a polycrystalline ceramic such as zirconia, yttria, scandia, ceria, or a combination thereof. In a further embodiment, the electrolyte can optionally be doped with at least one dopant selected from the group consisting of the oxides of Y, Hf, Ce, Ca, Mg, Sc, Nd, Sm, Eu, Gd, Tb, Dy, Ho, Er, Tm, Yb, Lu, In, Ti, Sn, Nb, Ta, Mo, W, or a mixture thereof. In yet a further embodiment, the electrolyte can comprise other filler or processing materials. In a specific embodiment, the electrolyte is comprised of zirconia doped with yttria.

The electrolyte can comprise any geometry suitable for the solid oxide fuel cell being fabricated. In one embodiment, the electrolyte is a sheet. In another embodiment, the electrolyte is tubular. In a preferred embodiment, the electrolyte is a thin sheet comprised of zirconia doped with yttria.

An electrolyte can further support or be sandwiched between at least one anode and at least one cathode, positioned on opposing surfaces of the electrolyte sheet. Electrolytes and electrolyte materials are commercially available (for example, Kerafol GmbH, Eschenbach, Germany) and one of skill in the art could readily select an appropriate electrolyte for a solid oxide fuel cell.

In several of the embodiments described herein, a solid oxide fuel cell can comprise a support frame. The frame of a conventional solid oxide fuel cell can be any such frame suitable for the design of solid oxide fuel cell being fabricated. The frame should be capable of providing support to the electrolyte sufficient to minimize strain and thus, prevent breakage. In various embodiments, the frame of a solid oxide fuel cell can comprise an electrically conductive or substantially electrically conductive material. In such an embodiment, the frame can comprise a stainless steel such as, for example, 430 stainless steel, 446 stainless steel, E-BRITE® stainless steel, or a combination thereof (available from Allegheny Ludlum Corporation, Pittsburgh, Pa., USA, or Precision Steel Warehouse, Inc., Franklin Park, Ill., USA). A frame can be machined from a suitable frame material, such as 446 stainless steel, to a form suitable frame for the fuel cell device being fabricated. In one embodiment, the frame can be in the form of a rectangular picture frame with a recessed area sized to accommodate an electrolyte sheet. In one embodiment, one or multiple frame members of a solid oxide fuel cell device comprise a stainless steel.

In another embodiment, the solid frame can be electrically non-conductive or substantially electrically non-conductive. The electrically non-conductive solid frame can comprise any material suitable for use in a solid oxide fuel cell. In one embodiment, the electrically non-conductive solid frame comprises an electrically non-conductive ceramic, glass, or glass-ceramic material, such as, for example, alumina, zirconia, a magnesia-spinel mixture, barium silicate, or a combination thereof. Ceramic, glass, and glass-ceramic materials are readily available (APC International, Ltd., Mackeyville, Pa., USA, or Washington Mills Electro Minerals Company, North Grafton, Mass., USA) and one of skill in the art could readily select an appropriate non-conductive solid frame material.

In another embodiment, a frame comprises a material resistant to hydrogen and/or other fuel gas compositions. In another embodiment, a frame comprises a material that is thermally stable at solid oxide fuel cell operating temperatures and at the temperatures incurred in startup and shutdown of a fuel cell, for example, from about ambient to about 1,000° C., preferably from about ambient to about 800° C., and more preferably from about ambient to about 750° C. In another embodiment, the frame has a coefficient of thermal expansion (CTE) substantially similar to that of the electrolyte, such as for example, from about 70×10⁻⁷/° C. to about 120×10⁻⁷/° C. over a temperature range of, for example, ambient to about 1,000° C. If multiple frame members are used, it is not necessary that each of the multiple frame members comprise the same material, have the same shape, and/or CTE.

### Felt Seal

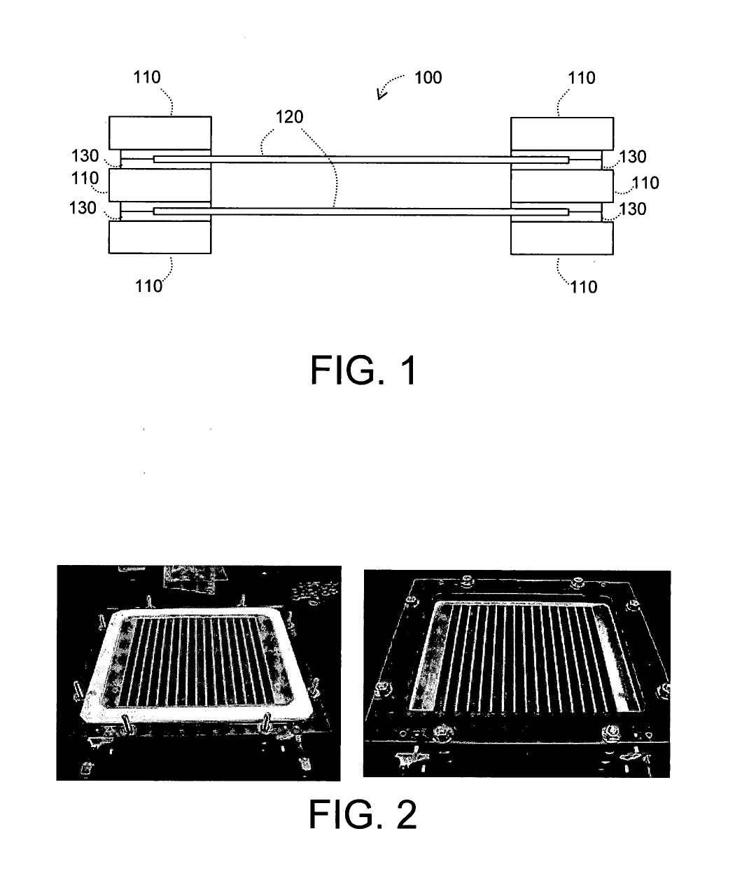

A solid oxide fuel cell can comprise, in various embodiments, a first frame member and a second frame member in partial or complete overlying registration, a ceramic electrolyte sheet at least partially disposed therebetween, and a seal that can connect at least a portion of the ceramic electrolyte sheet to at least a portion of one or more frame members. The seal can comprise any material suitable for use in a solid oxide fuel cell. In one embodiment, the seal comprises a ceramic felt, as illustrated in FIG. 1. A seal comprising a ceramic felt can allow for motion between the fuel cell device and the mounting frame at fuel cell operating temperatures of, for example, from about ambient to about 800° C. In one embodiment, a seal can accommodate a mismatch between the CTE of various components of a device. Such a mismatch can induce strain during a temperature ramp, such as during startup, and at operating temperatures, where a substantial temperature gradient can exist across the device.

A felt for use in a seal of a solid oxide fuel cell device can comprise any ceramic material suitable for use in a solid oxide fuel cell. In one embodiment, a felt comprises zirconia. In another embodiment, a felt can be chemically inert, for example, during fuel cell device operation. In yet another embodiment, a felt material can be sufficiently flexible to mold to and accommodate at a least a portion of any wrinkles or surface variations that can be present in the ceramic electrolyte sheet, frame, and/or other components.

In one embodiment, the felt can comprise a material that can be compressed. In such an embodiment, the felt can be compressed from an uncompressed starting thickness of, for example, about 0.3 inches to a compressed state with a thickness of, for example, about 0.1 inches or less. For example, the felt material can be compressed from an uncompressed starting thickness of about 0.25 inches to a compressed state with a thickness of about 0.09, 0.07, 0.05, 0.04, 0.03, or 0.01 inches or less. In another embodiment, a felt can comprise a material having a predetermined porosity, tensile strength, or shear strength, suitable for use in a specific solid oxide fuel cell design. In a preferred embodiment, the felt material can be chemically inert in the presence of, for example, other components and/or under operating conditions, such as, for example, oxidation or reduction. Further, if a felt seal is present, it is preferred that the felt seal not sinter or otherwise diffuse into adjacent material(s).

In yet other embodiments, a felt can comprise at least a partially flexible fiber that is capable of providing cushioning between the ceramic electrolyte sheet and the frame. In a preferred embodiment, the seal comprises a felt material capable of minimizing thermal mechanical stress on the ceramic electrolyte sheet and/or frame support structure. A felt seal can serve to cushion the ceramic electrolyte sheet during thermal expansion, for example, during fuel cell startup and shutdown, and/or other events that can lead to device component movement during device fabrication and/or operation. For example, in a specific embodiment, a felt seal can allow for enhanced lateral and/or medial movement of the ceramic electrolyte sheet with respect to a frame member. Improved mobility of the ceramic electrolyte sheet can minimize at least a portion of the potential for fracture of the ceramic electrolyte sheet. The felt seal can also mold to the ceramic electrolyte sheet and/or frame member without imparting harmful strain to the device.

In various embodiments, a felt seal is in partial or complete overlying registration with the first and/or second frame members. In this embodiment, the felt can be in different, identical, or substantially similar degrees of overlying registration with respect to the first and/or second frame members. In another embodiment, the felt seal is in partial or complete overlying registration with that portion of the ceramic electrolyte sheet disposed between the first and second frame members.

A seal system can comprise multiple seal components, such as ceramic felt seals. In an exemplary embodiment, as illustrated in FIG. 1, a solid oxide fuel cell assembly 100 can comprise a plurality of individual cells, each comprising a ceramic electrolyte sheet 120 positioned in a stacked arrangement with another individual cell and sealed to a frame member 110. Each ceramic electrolyte sheet 120 can support one or a plurality of electrode pairs 121 (cathode-anode pair(s)). That is, each ceramic electrolyte sheet 120 may support a plurality of interconnected electrode pairs, thus forming a plurality of fuel cells. Each seal can, in various embodiments, comprise multiple felt components 130, such as, for example, a first felt seal in partial or complete overlying registration with a first frame member and/or ceramic electrolyte sheet and a second seal in partial or complete overlying registration with a second frame member and/or ceramic electrolyte sheet. The first felt seal can connect and/or seal a first frame member to a portion of the one surface of a ceramic electrolyte sheet disposed between the first and second frame members. Similarly, the second felt seal can connect and/or seal a second frame member to a portion of an opposing surface of the ceramic electrolyte sheet disposed between the first and second frame members. An exemplary embodiment comprising three stacked ceramic electrolyte sheets (each sheet supporting multiple electrode pairs) sealed to individual frame members with a zirconia felt is depicted in FIG. 2.

Ceramic felt materials, such as, for example, zirconia felt, are commercially available (Zircar Zirconia, Inc., Florida, N.Y., USA). One of skill in the art could readily select an appropriate ceramic felt material for use in a seal for a solid oxide fuel cell device.

### Felt Seal Comprising Spacer

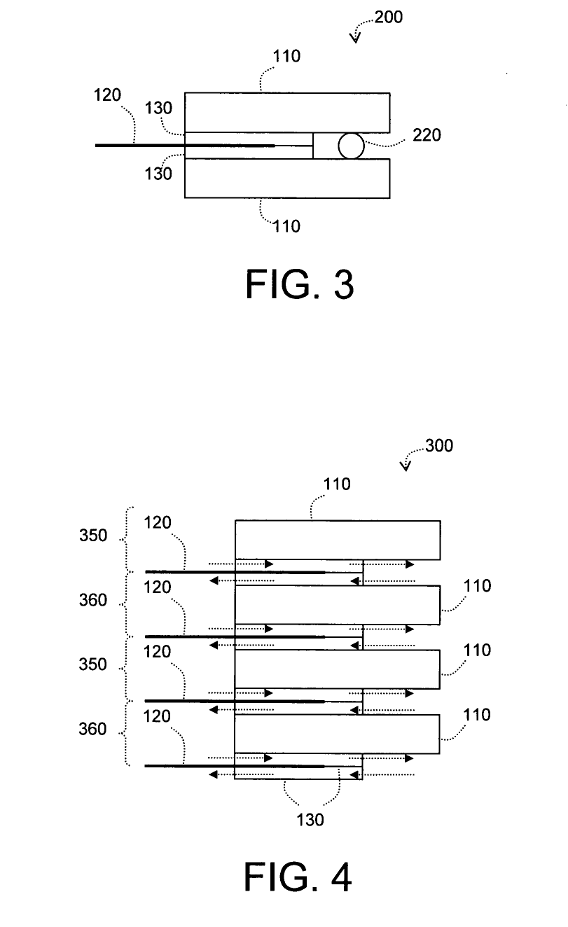

In another embodiment, as illustrated in FIG. 3, a fuel cell assembly 200 can comprise, in addition to a ceramic felt 130, one or more spacers 220 disposed between the first frame member 110 and the second frame member 110 and positioned adjacent to the ceramic electrolyte sheet 120. In one embodiment, a felt seal comprises a single spacer that forms a loop, extending around the periphery of a ceramic electrolyte sheet. In another embodiment, a plurality of individual spacers are disposed between the first and second frame members and adjacent to the ceramic electrolyte sheet at various locations around the periphery of the ceramic electrolyte sheet. For example, a rectangle shaped solid oxide fuel cell device can have four spacers, each positioned between a first and second frame member on an appropriate side of the solid oxide fuel cell device. In other embodiments, about 1, 3, 5, 7, 9, 10, 13, 15, 17, 20, 23, 28, 33, 35, 37, or 40 spacers can be used in a solid oxide fuel cell device. The spacer can at least partially prevent gas leakage from the device or device component by providing a solid barrier between the electrode chambers of a solid oxide fuel cell and the ambient environment surrounding a fuel cell device. In this embodiment, a spacer can also limit the compressive force applied to the seal system. In a specific embodiment, the spacer can be used as a molding template, such as to limit the compressive force applied to the ceramic electrolyte sheet and/or seal material. In another embodiment, the spacer can be a sacrificial component, and the spacer can be removed from a mounted ceramic electrolyte sheet after device fabrication.

A spacer positioned between the first frame member and the second frame member can have any geometrical shape compatible with a solid oxide fuel cell design. For example, the spacer can have a substantially tubular or rod-like geometrical shape. In a specific embodiment, the spacer can be a solid cylindrical rod. In another embodiment, the spacer can be a tube. The spacer can be partially or wholly disposed between the first and second frame members.

A spacer, if used, can be positioned adjacent to or spaced a predetermined distance from the edge of a ceramic electrolyte sheet. In one embodiment, a spacer is positioned adjacent to or substantially adjacent to the edge of a ceramic electrolyte sheet. In another embodiment, a spacer is positioned a predetermined distance from the edge of a ceramic electrolyte sheet, so as to allow for thermal expansion of the ceramic electrolyte sheet upon fuel cell startup and/or operation. A spacer can be used, either alone with a felt seal, or in combination with any of the seal embodiments described herein.

A spacer can comprise any material suitable for use in a solid oxide fuel cell. In one embodiment, a spacer can comprise a stainless steel such as, for example, 430 stainless steel, 446 stainless steel, E-BRITE® stainless steel, or a combination thereof (available from Allegheny Ludlum Corporation, Pittsburgh, Pa., USA, or Precision Steel Warehouse, Inc., Franklin Park, Ill., USA).

### Felt Seal Comprising a Cavity

A felt seal, as described above, can provide a flexible seal between a ceramic electrolyte sheet and a frame that can restrict gas diffusion or flow from one portion of the device through the seal, and into another portion of the device. FIG. 4 illustrates the diffusion of gas in a solid oxide fuel cell assembly 300 from one portion of the device to another, such as from a fuel cavity side 350 to an air cavity side 360. As felt seals, such as, for example, a zirconia felt seal, do not typically provide a gas tight seal, one or more additional seals can be utilized in combination with a felt seal.

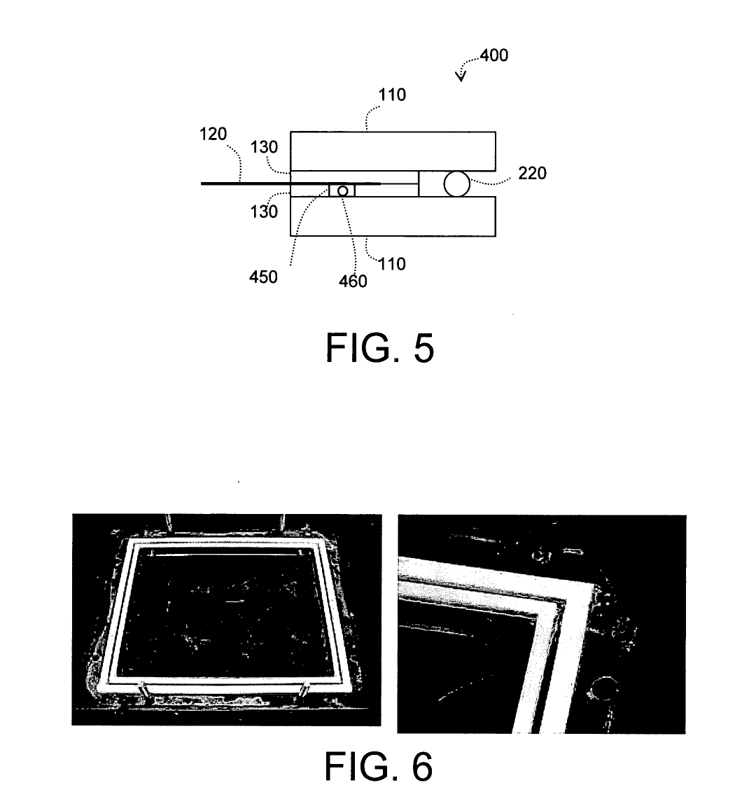

In one embodiment, a felt seal can comprise a channel or cavity into which a second material can be placed. Such a second material can, in various embodiments, provide further restriction to the diffusion and/or flow of gas than a felt seal alone. In one embodiment, a first and/or second felt seal 130, as described above, can define a cavity 450. (See FIG. 5). A cavity can be a channel or trench through at least a portion of the one or more individual felt seals. The dimensions of such a cavity can vary and the present invention is not intended to be limited to any particular dimensions for a cavity. In one embodiment, a cavity extends the entire thickness of at least one felt seal, from the ceramic electrolyte sheet to a frame member. In other embodiments, a cavity extends for a portion of the thickness of at least one felt seal and can be positioned in contact with the ceramic electrolyte sheet, a frame member, and/or disposed in the middle of a felt seal. The specific shape and alignment of a cavity or a portion thereof can vary, and the present invention is not limited to a specific shape and/or alignment of a cavity. In one embodiment, a cavity has a rectangular cross section and forms a rectangular loop within a portion of a felt seal, as illustrated in FIG. 6.

Any material suitable for use in a solid oxide fuel cell can be used to fill a cavity defined by a first and/or second seal member. It is not necessary that a cavity be completely filled with a material. In one embodiment, a cavity is filled or substantially filled with a material capable of restricting gas flow. In another embodiment, a cavity is at least partially filled with a material capable of restricting gas flow. In various embodiments, a cavity can comprise a solid metal, such as a wire, a powdered metal, a sintered metal, a powdered ceramic, a sintered ceramic, or a combination thereof. In yet another embodiment, a cavity defined by the seal can comprise cement. Any cement compatible with a solid oxide fuel cell design can be used. In a specific embodiment, a metallic powder, such as a metal powder having a high volumetric particle packing density, can be used to fill a cavity within the seal material. For example, in one embodiment, a powdered Ni Anti-Seize material (Mid-South Mechanical Seals, Inc., Montgomery, Ala., USA) can be used to fill the cavity. In another embodiment, a cavity 450 filled with a low porosity material can further comprise a solid component, such as, for example, a stainless steel rod 460 that can further impede gas flow and/or diffusion. (See FIG. 5.) In this embodiment, a stainless steel can comprise any suitable stainless steel, such as those described above with respect to the frame. The specific shape and size of a solid component, such as a stainless steel rod, if used, can be any such shape and size suitable for use with a specific fuel cell design. In yet another embodiment, a material used to fill the cavity defined by a first and/or second seal member can comprise one or more solid metal wires and/or other solid metal components in the form of powder and/or sintered metal, or a combination thereof.

A powdered metal and/or ceramic, if used, can optionally be capable of being sintered upon heating at an elevated temperature, such as, for example, a startup heating schedule of a solid oxide fuel cell. Such a sinterable metal and/or ceramic can conform, upon sintering, to the surface profile of the ceramic electrolyte sheet. Once sintered, a metal and/or ceramic can provide a restriction to gas flow and/or diffusion through the seal. A material for use in filling a cavity can comprise binders, additives, rheological aids, and the like that can be useful in storing, handling, and/or applying the material to a fuel cell device. For example, a powdered metal can optionally comprise one or more rheological aids to assist in applying the powdered metal to a fuel cell device.

Application of a material, such as a powdered metal, to the cavity of a felt seal can be performed by any suitable technique. In one embodiment, a powdered metal can be mixed with rheological aids and applied to at least a portion of the cavity as a paste.

FIG. 6 illustrates an exemplary seal wherein a felt seal has a channel and/or cavity into which a powdered metal can be added.

Solid components, powdered metals, sintered metals, powdered ceramics, and sintered ceramics are commercially available and one of skill in the art could readily select an appropriate material to fill a cavity defined by a first and/or second seal member for use in a solid oxide fuel cell device.

### Coated Ceramic Electrolyte Sheet

In each of the various embodiments, a portion of the ceramic electrolyte sheet, such as, for example, that portion of the ceramic electrolyte sheet disposed between the first and second frame members, can comprise a coating. Such a coating can provide additional cushioning between the ceramic electrolyte sheet and, for example, a frame member. A coating can also provide a temporary adhesion barrier between the ceramic electrolyte sheet and frame and/or seal. A coating material can comprise any material suitable for use in a solid oxide fuel cell device, such as, for example, a wax or mounting adhesive. In one embodiment, a coating can comprise a material capable of being volatilized, combusted, or a combination thereof, at an elevated temperature, such as, for example, a fuel cell operating temperature. In a specific embodiment, a wax can be used as a coating material. For example, in one embodiment, Aremco Crystalbond™ 509 (Aremco Products, Inc., Valley Cottage, N.Y., USA) can be used as a mounting adhesive and coating material. In this embodiment, the wax coating can be volatilized during heating of the device, at a temperature of from about 700° C. to about 1000° C. In other embodiments, a coating material can comprise other components, such as a solvent or diluent that can provide, for example, desired rheological properties to the coating material. In a specific embodiment, a wax coating material can comprise a solvent, such as acetone, to better facilitate application of a thin layer of the wax coating material.

A coating can be applied to any portion of one or more surfaces of a ceramic electrolyte sheet. In one embodiment, at least a portion of the ceramic electrolyte sheet disposed between the first and second frame members comprises a coating. It is preferred that the coating not be applied to the electrode area of a ceramic electrolyte sheet. A coating, if used, can be applied to discrete portions or to, for example, the entire periphery of a ceramic electrolyte sheet that would a seal between the ceramic electrolyte sheet and a frame member.

Mounting adhesives, waxes, and other coating materials are commercially available and one of skill in the art could readily select an appropriate coating for use in a solid oxide fuel cell device.

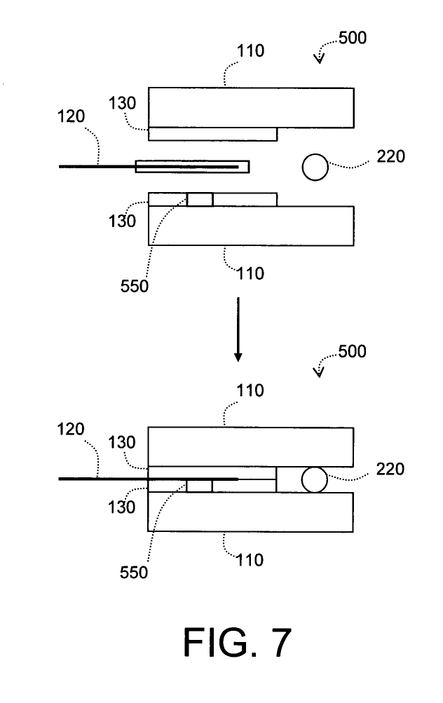

FIG. 7 illustrates an exemplary solid oxide fuel cell assembly 500 having a spacer 220, a felt 130 seal having a cavity 550, and a ceramic electrolyte sheet 120 having a portion of an edge thereof coated with a wax, all being disposed between a first and a second frame member. Such a coating can prevent the ceramic electrolyte sheet from, for example being bonded to or sticking to a material applied in the cavity 550. After assembly and compression of the device, and after heating at an elevated temperature, the coating volatilizes and/or combusts, optionally leaving a small gap between the previously coated edge of the ceramic electrolyte sheet and the felt seals, facilitating free movement during thermal expansion, but not substantially affecting the restriction of gas flow through the seal.

A coating, such as, for example, a wax coating, can be applied to a portion of a ceramic electrolyte sheet by any suitable method. In various embodiments, a coating material, such as a wax, can be applied to a portion of a ceramic electrolyte sheet via a spraying or brushing technique. In other embodiments, a portion of a ceramic electrolyte sheet can be dipped into a bath of the coating material and slowly be withdrawn, leaving a coating of the material on the dipped portion of the ceramic electrolyte sheet.

The thickness of a coating on a portion of a ceramic electrolyte sheet can vary, depending upon the coating material and the specific seal and/or seals to be used in a fuel cell device. In one embodiment, a coating comprises a thin layer on at least one surface of a ceramic electrolyte sheet. In another embodiment, a coating comprises thin layers on opposing sides of a ceramic electrolyte sheet. In various embodiments, a coating can be from about 1 μm to about 100 μm thick, for example, about 1, 2, 5, 10, 15, 20, 25, 30, 35, 40, 45, 50, 60, 70, 80, 90, or 100 μm thick. In a specific embodiment, a coating can be about 50 μm thick on at least one side of a ceramic electrolyte sheet. The specific thickness of a coating material can be adjusted so as to provide a gap within a seal having a predetermined thickness. The thickness of a gap created by, for example, volatilization of a coating material upon heating, can be about the thickness of the applied coating material or less. In one embodiment, a gap has a thickness substantially similar to the thickness of the applied coating. In another embodiment, other seal components, such as, for example, a felt seal, can expand to fill a gap created by a volatilized coating material. It is not necessary that a seal formed, in part, with a coating material comprise a gap as the coating, in various embodiments, can be used to prevent adhesion between seal components alone. In a preferred embodiment, thickness of a coating and hence, the thickness of the resulting gap, is minimized. In a specific embodiment, a gap is less than about 10 μm. In another specific embodiment, a gap is about 1 μm or less.

A gap, if one exists, in an assembled seal, can form a labyrinth and/or cushion between the electrolyte sheet and the frame, and can provide additional room for the movement of the ceramic electrolyte sheet during device fabrication and/or operation.

### Solid Oxide Fuel Cell Comprising a Felt Seal and a Secondary Seal

In addition to a felt seal, as described in various embodiments above, the present invention also provides a seal system comprising a felt seal and a secondary seal. The secondary seal can be any suitable seal or seal system that can provide mechanical stability to the ceramic electrolyte sheet, resistance to gas diffusion and/or leakage, or a combination thereof.

In various embodiments, a secondary seal can comprise a moldable material that can form a seal around a portion of a ceramic electrolyte sheet, for example, under compression. A seal formed from such a secondary seal material can be formed, for example, adjacent to one or more felt seals and positioned, for example, at the peripheral edge of a ceramic electrolyte sheet. As for the other seals and methods described herein, a secondary seal can extend for a portion of or the complete peripheral edge of a ceramic electrolyte sheet. In one embodiment, a secondary seal extends along a portion of at least one edge of a ceramic electrolyte sheet. In another embodiment, a secondary seal extends the complete periphery of a ceramic electrolyte sheet.

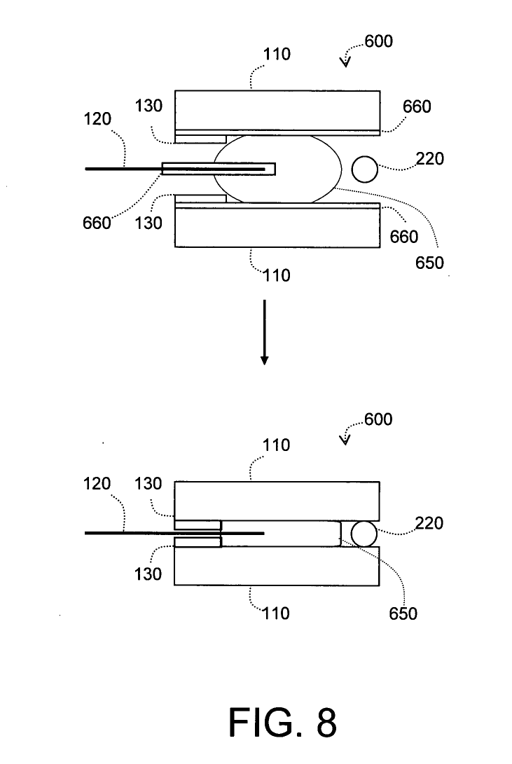

A secondary seal can be formed around an edge of a ceramic electrolyte sheet such that, after forming, a portion of an edge of a ceramic electrolyte sheet is disposed within the secondary seal material, forming a labyrinth as illustrated in FIG. 8.

Depending upon the specific fuel cell design and secondary seal material, a ceramic electrolyte sheet can optionally have at least a portion of an edge thereof coated with a coating material, as described here. In one embodiment, a ceramic electrolyte sheet has a coating, such as, for example, a wax, applied to at least a portion of an edge thereof. In another embodiment, a ceramic electrolyte sheet does not have a coating applied to a portion of an edge thereof. A coating material, if utilized, can prevent or reduce adhesion between the secondary seal material and that portion of a ceramic electrolyte sheet disposed therein.

A secondary seal material can comprise any suitable rheology or other physical properties that can affect the use and application thereof. In one embodiment, a secondary seal material can comprise a cement. In a specific embodiment, a secondary seal material can comprise a cement, such as, for example, Aremco Ceramacast™ 575N (Aremco Products, Inc., Valley Cottage, N.Y.). In this embodiment, a cement precursor can be provided in a powder form such that when the precursor is mixed with water, a cement is formed. The secondary seal material can comprise a material that can harden and/or cure, or can remain flexible upon heating. In one embodiment, a secondary seal material hardens and/or cures upon heating to, for example, a fuel cell operating temperature.

A secondary seal material, such as a cement, can be applied to one or both surfaces of a ceramic electrolyte sheet, and/or can be positioned between a first and second frame member such that a ceramic electrolyte sheet can be inserted into at least a portion thereof.

When a solid oxide fuel cell having a felt and a secondary seal is assembled and compressed, the secondary seal material can conform around the surface of that part of a ceramic electrolyte sheet disposed therein, and conform to the surfaces of the first and/or second frame members between which the secondary seal is disposed. FIG. 8 illustrates an exemplary solid oxide fuel cell assembly design 600 having a felt seal and a secondary seal comprising a cement. A quantity of cement 650 can be positioned between a first and second frame member 110, such that a ceramic electrolyte sheet 120, wherein the cement encapsulates at least a portion of an edge of the ceramic electrolyte sheet 120. That portion of the ceramic electrolyte sheet encapsulated in the cement can optionally be coated with a coating material 660, such as a wax, to prevent adhesion between the cement and the ceramic electrolyte sheet. Such a design can also optionally comprise a spacer material 220, as described above, positioned between the frame members and adjacent to the ceramic electrolyte sheet and/or the cement secondary seal. A felt seal 130 can be positioned between one or both sides of a ceramic electrolyte sheet and the respective frame member. Additionally, the interior surfaces (facing the seal and ceramic electrolyte sheet) of the first and/or second frame members can be coating with a coating material 660, as described above with respect to the ceramic electrolyte sheet. Such a coating can volatilize and/or combust upon heating, and can prevent or reduce adhesion of the secondary seal material to the frame members, thus providing the capability to move upon, for example, thermal expansion of fuel cell components.

The thickness of a secondary seal can be any thickness suitable for sealing a ceramic electrolyte sheet in a solid oxide fuel cell. In one embodiment, a secondary seal, after compression, has a thickness approximately equal to the thickness of the one or more compressed felt seals and the ceramic electrolyte sheet. In various embodiments, a secondary seal can have a thickness of from about 0.1 mm to about 3 mm. In other embodiments, a secondary seal can have a thickness less than about 0.1 mm or greater than about 3 mm. For example, a secondary seal comprising a material, such as cement, can have a compressed thickness of about 0.09, 0.15, 0.2, 0.5, 0.7, 1, 1.2, 1.5, 1.7, 2, 2.3, 2.6, 2.9, or 3 mm.

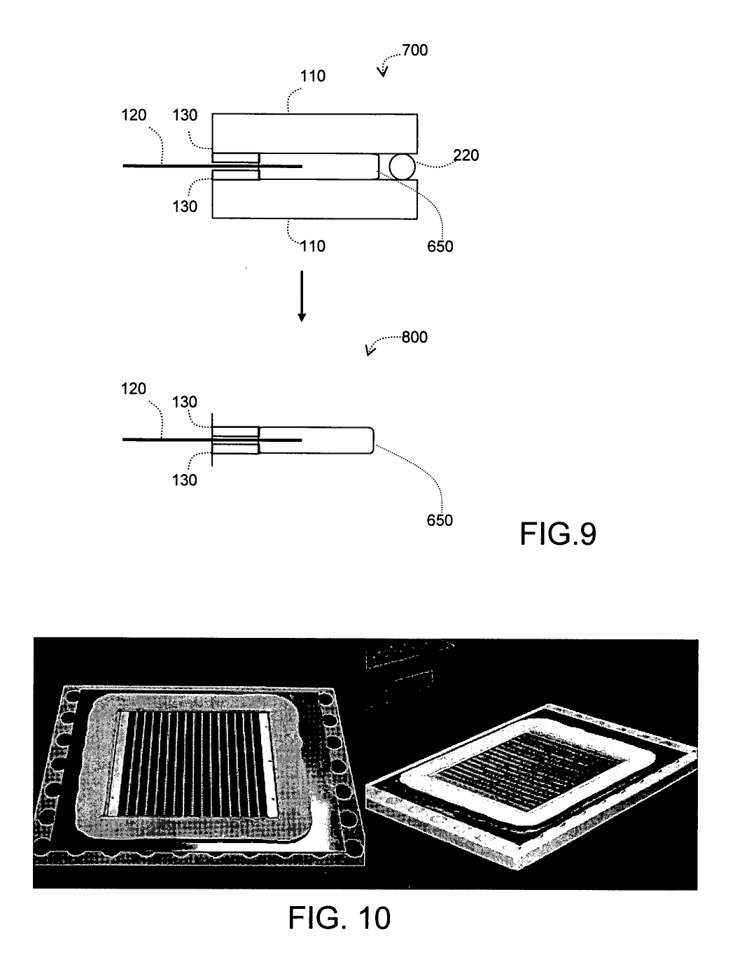

In another embodiment, a solid oxide fuel cell having a felt seal and a secondary seal can be frameless. In such an embodiment, as illustrated in FIG. 9, a ceramic electrolyte sheet can be sealed with a felt seal and a secondary seal as described above, except that the one or more frame members serve as a mold to compress and/or shape the secondary seal material. After forming the secondary seal of such an embodiment, the one or more frame members can be removed, leaving a sealed ceramic electrolyte sheet 800 at least partially encapsulated in a labyrinth of the secondary seal material. A photograph of an exemplary frameless felt and secondary seal is depicted in FIG. 10. One or more frameless sealed ceramic electrolyte sheets can be arranged, for example, in partial or overlying registration, to form a fuel cell stack. Such as design can result in reduced cost and volume of a fuel cell stack.

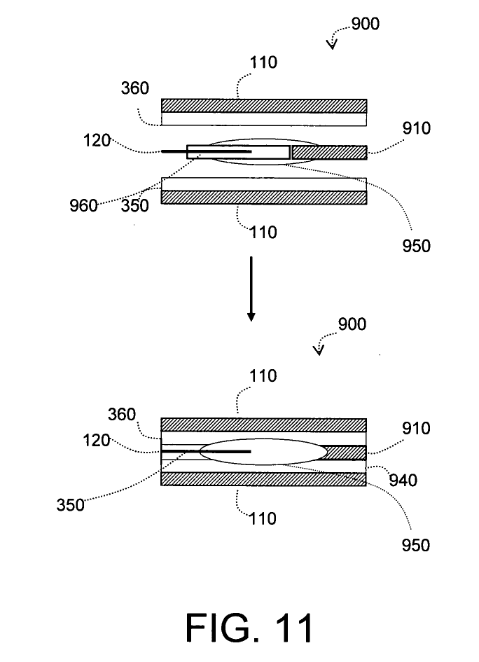

In yet a further embodiment, a ceramic electrolyte sheet can be sealed to a peripherally mounted frame member 910, as illustrated in FIG. 11. In such an embodiment, an edge of a ceramic electrolyte sheet 120 having an optional wax coating can be at least partially encapsulated in a secondary seal material as described above. A peripheral frame member can also be at least partially encapsulated in the secondary seal material. In one embodiment, the peripheral frame is positioned in substantially the same plane as the ceramic electrolyte sheet and is positioned on an opposing side of the secondary seal, such that the secondary seal forms a bridge between the ceramic electrolyte sheet and the peripheral frame. Such a peripherally mounted ceramic electrolyte sheet can optionally be disposed between a first and second frame member so as to provide an air cavity 360 on one surface of the ceramic electrolyte sheet and a hydrogen cavity 350 on the opposing side of the ceramic electrolyte sheet.

Although several embodiments of the present invention have been described in the detailed description, it should be understood that the invention is not limited to the embodiments disclosed, but is capable of numerous rearrangements, modifications and substitutions without departing from the spirit of the invention as set forth and defined by the following claims.

### EXAMPLES

To further illustrate the principles of the present invention, the following examples are put forth so as to provide those of ordinary skill in the art with a complete disclosure and description of how the compositions, assemblies, articles, devices, and methods claimed herein are made and evaluated. They are intended to be purely exemplary of the invention and are not intended to limit the scope of what the inventors regard as their invention. Efforts have been made to ensure accuracy with respect to numbers (e.g., amounts, temperatures, etc.); however, some errors and deviations should be accounted for. Unless indicated otherwise, temperature is ° C. or is at ambient temperature, and pressure is at or near atmospheric. There are numerous variations and combinations of process conditions that can be used to optimize product quality and performance. Only reasonable and routine experimentation will be required to optimize such process conditions.

### Example 1

In a first example, a number of solid oxide fuel cell assemblies, such as that depicted in FIG. 3, were constructed by attaching a zirconia felt seal between stainless steel frame members and a ceramic electrolyte sheet with a stainless steel spacer rod spacer disposed between the frame members and adjacent to the ceramic electrolyte sheet. The assemblies/devices were then tested to determine thermomechanical integrity with various levels of compression between the frame members. When a spacer having a diameter between about 0.115 and about 0.145 inches was used, little to no cracking of the ceramic electrolyte sheet was observed after thermal cycling. The assemblies/devices were tested further by observing the ceramic electrolyte sheet at operating temperature with a 5.0 L/min flow of N₂ through the gas manifold of the device. When rod spacers with diameters of about 0.115 to about 0.135 were used at operating temperatures, little to no cracking of the ceramic electrolyte sheets was observed. The results are summarized in Table 1.

TABLE 1
Results of Thermal Cycling and Operating Tests

| Spacer diameter/ | Felt Thickness/ | Thermal Cycle | |
|---|---|---|---|
| inches | inches | Results | N₂ Baseline Result |
| 0.095 | 0.048 | Large cracks | NA |
| 0.105 | 0.053 | Small cracks | NA |
| 0.115 | 0.058 | No cracks | No cracks |
| 0.125 | 0.063 | No cracks | No cracks |
| 0.135 | 0.068 | No cracks | No cracks |
| 0.145 | 0.073 | No cracks | Ballooning/cracks |

### Example 2

In a second example, a plurality of solid oxide fuel assemblies, such as depicted in FIG. 3, were tested to determine the extent of gas leakage. For each device, a zirconia felt seal with an original uncompressed thickness of about 0.1 inches was compressed between a ceramic electrolyte sheet and a first and second frame member. Leakage coefficients were measured at various compression levels of the zirconia felt seal.

The leakage coefficient of a given felt seal can be defined by the following relationship:

$$Leakage Coefficient = \frac{Leakage ( L \text{/} min ) \times Gasket width ( mm )}{Pressure ( Pa ) \times Gasket perimeter ( mm )}$$

For a plurality of devices, gas leakage can be estimated based on the amount of felt compression and gasket dimensions according to the following relationship:

$$Leakage ( L \text{/} min ) = \frac{Pressure ( Pa ) \times Gasket perimeter ( mm ) \times Leakage coefficient}{GasketWidth ( mm )}$$

Using the above cited relationships, gas leakage through assemblies were measured. Generally, a thinner zirconia felt seal resulted in a corresponding smaller leakage coefficient and thus a lower amount of gas leakage through the seal and/or device. For example, when a zirconia felt gasket with a 1,600 mm perimeter was compressed to about 0.058 inches from an original thickness of about 0.1 inches, a predicted leakage coefficient of about 1.44×10⁻⁴ corresponded well with a measured value of about 1.5×10⁻⁴. Such a leakage coefficient corresponds to about 0.2 L/min of gas leakage from the device.

Various modifications and variations can be made to the compositions, articles, devices, and methods described herein. Other embodiments of the compositions, articles, devices, and methods described herein will be apparent from consideration of the specification and practice of the compositions, assemblies, articles, devices, and methods disclosed herein. It is intended that the specification and examples be considered as exemplary.

What is claimed is:

1. A solid oxide fuel cell assembly comprising:
a first frame member,
a second frame member,
a ceramic electrolyte sheet having a first surface and an opposed second surface, the ceramic electrolyte sheet being at least partially disposed between the first and second frame member; and
a seal system comprising a first felt seal connecting at least a portion of the first frame member to at least a portion of the first surface, and a second felt seal connecting at least a portion of the second frame member to at least a portion of the second surface; and a spacer disposed between the first frame member and the second frame member and positioned adjacent to the ceramic electrolyte sheet, the spacer being capable of limiting a compressive force applied to the seal system.

2. The solid oxide fuel cell assembly of claim 1, wherein at least one of the first felt seal and/or the second felt seal comprises a zirconia felt.

3. The solid oxide fuel cell assembly of claim 1, wherein the spacer is position so as to restrict a diffusion of gas through at least one of the first and/or second felt seal.

4. A solid oxide fuel cell assembly comprising:
a first frame member,
a second frame member,
a ceramic electrolyte sheet having a first surface and an opposed second surface, the ceramic electrolyte sheet being at least partially disposed between the first and second frame member; and
a seal system comprising:
a first felt seal connecting at least a portion of the first frame member to at least a portion of the first surface, and a second felt seal connecting at least a portion of the second frame member to at least a portion of the second surface;
wherein at least one of the first felt seal and/or the second felt seal define a cavity in contact with the ceramic electrolyte sheet, and
wherein the cavity comprises at least one of:
a solid metal wire, a powdered metal, a sintered metal, a powdered ceramic, a sintered ceramic, or a combination thereof.

5. The solid oxide fuel cell assembly of claim 2, wherein at least a portion of the first and/or second surface of the ceramic electrolyte sheet positioned between the first and second frame members comprises a coating.

6. The solid oxide fuel cell assembly of claim 3, wherein the coating comprises a material capable of being volatilized, combusted, or a combination thereof at an elevated temperature.

7. The solid oxide fuel cell assembly of claim 4, wherein the coating comprises a wax.

8. A solid oxide fuel cell assembly comprising:
a first frame member,
a second frame member,
a ceramic electrolyte sheet having a first surface and an opposed second surface, the ceramic electrolyte sheet being at least partially disposed between the first and second frame member; and
a seal system comprising:
a first felt seal connecting at least a portion of the first frame member to at least a portion of the first surface, and a second felt seal connecting at least a portion of the second frame member to at least a portion of the second surface; and
a labyrinth seal comprising a secondary seal material in contact with at least a portion of the first frame member and at least a portion of the second frame member, wherein the secondary seal material defines a channel, and wherein at least a portion of the ceramic electrolyte sheet is disposed in at least a portion of the channel.

9. A mounted ceramic electrolyte sheet comprising:
a ceramic electrolyte sheet having a first surface and an opposed second surface,
a metal frame positioned adjacent to the ceramic electrolyte sheet, and
a labyrinth seal, wherein the labyrinth seal defines a first channel and an opposite disposed second channel, wherein at least a portion of the ceramic electrolyte sheet is disposed in at least a portion of the first channel, and
wherein at least a portion of the metal frame is disposed in at least a portion of the second channel.

10. A solid oxide fuel cell assembly comprising a plurality of the mounted ceramic electrolyte sheets of claim 9, wherein each of the plurality of electrolyte sheets is positioned in substantially overlying registration.
